(19) United States
(12) Patent Application Publication
(10) Pub. No.: US 2010/0274999 A1
(43) Pub. Date: Oct. 28, 2010

(54) CONTROL SYSTEM AND METHOD FOR MEMORY

(75) Inventor: Hung-Ju Chen, Tu-Cheng (TW)

Correspondence Address: Altis Law Group, Inc.;ATTN: Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/468,827

(22) Filed: May 19, 2009

(30) Foreign Application Priority Data
Apr. 25, 2009 (CN) 200910301851.9

(51) Int. Cl. G06F 15/177; G06F 12/00; G06F 12/02

(52) U.S. Cl. 713/2; 711/115; 711/E12.001; 711/E12.008; 711/103

(57) ABSTRACT

A control system for a number of memories includes a processor, a control chip, and an expansion chip. The processor is connected to a basic input and output system and the control chip. The control chip is also connected to a number of first memory cards and the expansion chip. The expansion chip is also connected to a number of second memory cards.

### BACKGROUND

1. Technical Field

The present disclosure relates to control systems and methods for memories, and particularly to a control system and a control method for a plurality of memories of memory cards plugged in a motherboard of a computer.

2. Description of Related Art

Common readable and writable storage mediums, such as memory cards, are generally plugged in memory sockets on a motherboard of a computer, and are controlled by a control chip, such as a south bridge chip or a north bridge chip. An control chip commonly has only one bus for connection to and control only a few memory cards (e g. eight memory cards). However, more and more memory sockets are needed on motherboards to meet high capacity requirements, and the control chip has no extra buses to connect to so many memory cards at once and cannot control all the memories of the memory cards.

### BRIEF DESCRIPTION OF THE DRAWINGS

FIG. 1 is a block diagram of an exemplary embodiment of a control system for memories, together with a basic input and output system (BIOS) and a plurality of groups of memory cards.

FIG. 2 is a flowchart of an exemplary embodiment of a control method for memories.

### DETAILED DESCRIPTION

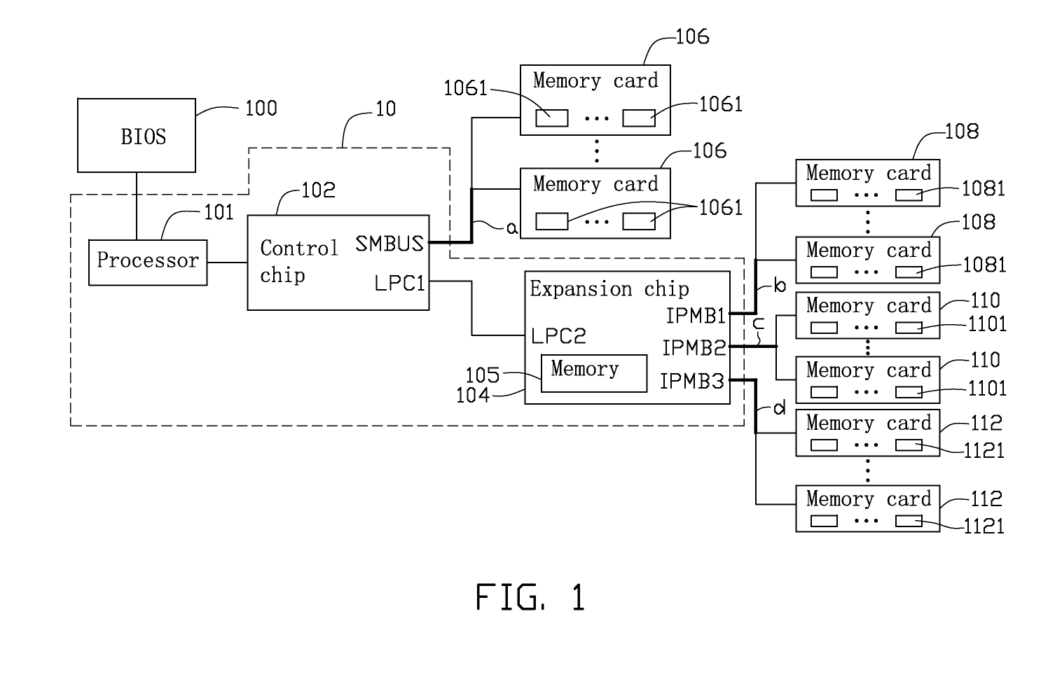

Referring to FIG. 1, an exemplary embodiment of a control system 10 for memories is disclosed for expanding a plurality of bus ports to connect to four groups of memory cards 106, 108, 110 and 112 and to control a plurality of memories 1061, 1081, 1101, 1121, of the groups of memory cards 106, 108, 110 and 112. The control system 10 includes a processor 101, a control chip 102, and an expansion chip 104. The processor 101 can be a central processing unit (CPU). The control chip 102 can be a north bridge chip, a south bridge chip, or other system chipset. The expansion chip 104 can be a baseboard management controller (BMC). In this embodiment there are eight memory cards in each group of memory cards 106, 108, 110 and 112.

The processor 101 is connected to a basic input and output system (BIOS) 100 and the control chip 102. The control chip 102 includes a low pin count port LPC1 and a system management bus port SMBUS. The system management bus port SMBUS is connected to a bus a. The bus a is connected to the group of memory cards 106, to enable the control chip 102 to communicate with a plurality of memories 1061 of the group of memory cards 106. The expansion chip 104 includes a low pin count port LPC2, a memory 105, three intelligent platform management bus ports IPMB1, IPMB2, and IPMB3. In other embodiments, the number of the intelligent platform management bus ports is not limited to be three. The low pin count port LPC2 of the expansion chip 104 is connected to the low pin count port LPC1 of the control chip 102, to enable the control chip 102 to communicate with the expansion chip 104. The intelligent platform management bus ports IPMB1, IPMB2 and IPMB3 are connected to buses b, c, and d respectively. The buses b, c, d are connected to the three groups of memory cards 108, 110 and 112 respectively to enable the expansion chip 104 to communicate with a plurality of memories 1081, 1101, and 1121 of the three groups of memory cards 108, 110, and 112.

The processor 101 is to send an initialization command output from the BIOS 100 to the control chip 102, to initialize the control system 10. In one embodiment, the initialization command can be serial presence detect (SPD) data, such as voltages or row/column addresses, of the plurality of memories 1061, 1081, 1101, and 1121 of the groups of memory cards 106, 108, 110, and 112.

The control chip 102 is to receive the initialization command. When the initialization command received by the control chip 102 is to initialize the plurality of memories 1061 of the group of memory cards 106, the control chip 102 reads corresponding information of the plurality of memories 1061 of the group of memory cards 106 (e.g. the SPD data of the memories 1061), and sends the information to the processor 101. When the initialization command is to initialize the plurality of memories 1081, 1101, 1121 of the group of memory cards 108, 110, or 112, the control chip 102 sends the initialization command to the expansion chip 104.

The expansion chip 104 is to pre-store the data (e.g. SPD data) of the plurality of memories 1081, 1101, 1121 of the groups of memory cards 108, 110, and 112 in the memory 105 when the control system 10 is powered on. When the control system 10 is initialized and the expansion chip 104 receives the initialization command from the control chip 102, the expansion chip 104 reads the corresponding information (e.g. the SPD data of the plurality of memories 1081, 1101, 1121 of the groups of memory cards 108, 110 and 112) from the memory 105 and sends the information to the control chip 102.

In detail, when the control system 10 is powered on, the expansion chip 104 pre-stores data (e.g. SPD data of the plurality of memories 1081, 1101, 1121 of the groups of memory cards 108, 110, and 112) in the memory 105 via the intelligent platform management bus ports IPMB1, IPMB2, and IPMB3. When the control system 10 is initialized, the BIOS 100 sends an initialization command for the plurality of memories 1081, 1101, 1121 of the groups of memory cards 106, 108, 110, and 112 to the control chip 102 via the processor 101. The control chip 102 reads the corresponding information of the plurality of memories 1061 of the group of memory cards 106 via the system management bus port SMBUS, and sends the information to the BIOS 100 via the processor 101. The control chip 102 also sends the initialization command for the plurality of memories 1081, 1101, 1121 of the groups of memory cards 108, 110, and 112 to the low pin count port LPC2 of the expansion chip 104 via the low pin count port LPC1. The expansion chip 104 reads the corresponding information of the plurality of memories 1081, 1101, 1121 of the groups of memory cards 108, 110, and 112 from the memory 105, and sends the information to the BIOS 100 via the low pin count port LPC2, the low pin count port LPC1 of the control chip 102, and the processor 101.

In other embodiments, when the control system 10 is powered on, the expansion chip 104 may not store data (e.g. SPD data of the plurality of memories 1081, 1101, 1121 of the groups of memory cards 108, 110, and 112) in the memory 105 via the intelligent platform management bus ports IPMB1, IPMB2, and IPMB3, but may instead read the data from the plurality of memories 1081, 1101, 1121 of the groups of memory cards 108, 110, and 112, upon receiving the initialization command and send the data to the control chip 102.

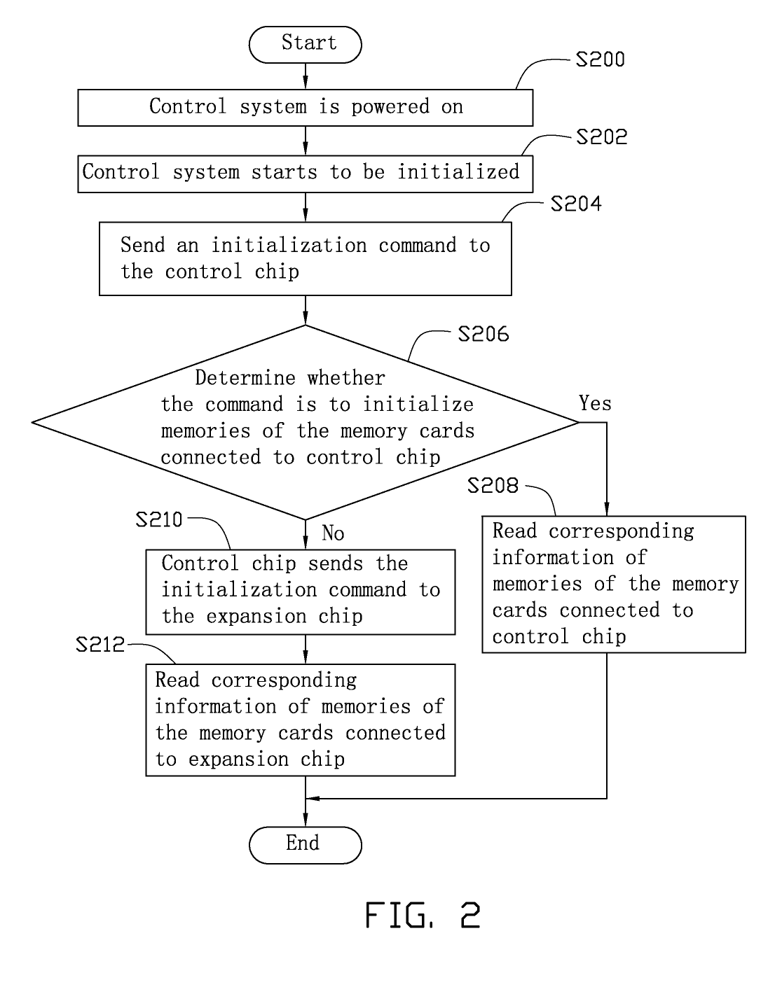

FIG. 2 is of an exemplary embodiment of a control method applied in the above mentioned control system 10 for expanding a plurality of bus ports to connect to four groups of memory cards 106, 108, 110, and 112 and to control a plurality of memories 1061, 1081, 1101, 1121 of the groups of memory cards 106, 108, 110, and 112. The control method includes the following steps.

In step S200, the control system 10 is powered on, the expansion chip 104 pre-stores data (e.g. SPD data of the plurality of memories 1081, 1101, 1121 of the groups of memory cards 108, 110, and 112) in the memory 105 via the intelligent platform management bus ports IPMB1, IPMB2, and IPMB3.

In step S202, the control system 10 starts to be initialized.

In step S204, the BIOS 100 sends an initialization command for the plurality of memories 1061, 1081, 1101, 1121 of the groups of memory cards 106, 108, 110, and 112 to the control chip 102 via the processor 101.

In step S206, the control chip 102 determines whether the initialization command is to initialize the plurality of memories 1061 of the group of memory cards 106 connected to the control chip 102 (e.g. the SPD data of the plurality of memories 1061 of the group of memory cards 106), if yes, the procedure goes to step S208, if not, the procedure goes to step S210.

In step S208, the control chip 102 reads the corresponding information (e.g. SPD data of the plurality of memories 1061 of the group of memory cards 106) via the system management bus port SMBUS, and sends the information to the BIOS 100 via the processor 101, and then the procedure ends.

In step S210, the control chip 102 sends the initialization command to the low pin count port LPC2 of the expansion chip 104 via the low pin count port LPC1.

In step S212, the expansion chip 104 reads the corresponding information of the plurality of memories 1081, 1101, 1121 of the groups of memory cards 108, 110, and 112 (e.g. the SPD data of the plurality of memories 1081, 1101, 1121 of the groups of memory cards 108, 110, and 112) from the memory 105, and sends the information to the BIOS 100 via the low pin count port LPC2, the low pin count port LPC1 of the control chip 102, and the processor 101, and then the procedure ends.

It is to be understood, however, that even though numerous characteristics and advantages of the embodiments have been set forth in the foregoing description, together with details of the structure and function of the embodiments, the disclosure is illustrative only, and changes may be made in details, especially in matters of shape, size, and arrangement of parts within the principles of the embodiments to the full extent indicated by the broad general meaning of the terms in which the appended claims are expressed.

What is claimed is:

1. A control system for a plurality of memories, comprising:
a processor to connect to a basic input and output system (BIOS), to receive an initialization command output from the BIOS when the control system is initialized;
a control chip connected to the processor to receive the initialization command from the processor, wherein the control chip is to connect to a plurality of first memory cards each comprising a plurality of first memories; and
an expansion chip connected to the control chip and to connect to a plurality of second memory cards each comprising a plurality of second memories, wherein the expansion chip receives the initialization command from the control chip in response to the initialization command for the plurality of second memories of the plurality of second memory cards;
wherein the control chip reads corresponding information of the plurality of first memories of the plurality of first memory cards, and sends the information to the processor, in response to the initialization command is to initialize the plurality of first memories of the plurality of first memory cards;
wherein the control chip outputs the initialization command to the expansion chip to control the expansion chip to read corresponding information of the plurality of second memories of the plurality of second memory cards, and to send the information to the BIOS via the control chip and the processor, in response to the initialization command to initialize the plurality of second memories of the plurality of second memory cards.

2. The system of claim 1, wherein the control chip comprises a system management bus port and a first low pin count port, wherein the system management bus port is to connect to the plurality of the first memory cards, and the first low pin count port is connected to the expansion chip.

3. The system of claim 2, wherein the expansion chip comprises a second low pin count port and a plurality of intelligent platform management bus ports, wherein the second low pin count port is connected to the first low pin count port of the control chip, and each intelligent platform management bus port is connected to a plurality of corresponding second memory cards.

4. The system of claim 1, wherein the expansion chip comprises a memory to pre-store the corresponding information of the plurality of the second memories of the plurality of second memory cards.

5. The system of claim 1, wherein the processor is a central processing unit.

6. The system of claim 1, wherein the control chip is a south bridge chip.

7. The system of claim 1, wherein the control chip is a north bridge chip.

8. The system of claim 1, wherein the expansion chip is a baseboard management controller.

9. A control method for a plurality of memories, comprising:
sending an initialization command from a basic input and output system (BIOS) to a control chip via a processor;
determining whether the initialization command is to initialize a plurality of first memories of a plurality of first memory cards connected to the control chip;
reading corresponding information from the plurality of first memories of the plurality of first memory cards via the control chip, and sending the information to the BIOS via the processor, in response to that the initialization command is to initialize the plurality of first memories of the plurality of first memory cards; and
sending the initialization command to the expansion chip connected to the control chip, and reading corresponding information of a plurality of second memories of a plurality of second memory cards connected to the expansion chip, and sending the information to the BIOS via the control chip and the processor, in response to that the initialization command is to initialize the plurality of second memories of the plurality of second memory cards.

10. The method of claim 9, wherein the expansion chip comprises a memory to pre-store the corresponding information of the plurality of second memories of the plurality of second memory cards.

11. The method of claim 9, wherein the processor is a central processing unit, the control chip is a south bridge chip, and the expansion chip is a baseboard management controller.

12. The method of claim 9, wherein the control chip is a north bridge chip.
